(19) United States
(12) Patent Application Publication
(10) Pub. No.: US 2012/0309331 A1
(43) Pub. Date: Dec. 6, 2012

(54) MODULAR MILLIMETER-WAVE RADIO FREQUENCY SYSTEM

(75) Inventors: Alon YEHEZKELY, Haifa (IL); Sagi KUPFERMAN, Tel Aviv-Yafo (IL)

(73) Assignee: WILOCITY, LTD., Caesarea (IL)

(21) Appl. No.: 13/312,127

(22) Filed: Dec. 6, 2011

Related U.S. Application Data
(63) Continuation-in-part of application No. 13/153,667, filed on Jun. 6, 2011.

(51) Int. Cl. H04B 7/02

(52) U.S. Cl. 455/101

(57) ABSTRACT

A modular millimeter-wave radio frequency (RF) system comprises a plurality of active antenna arrays for receiving and transmitting millimeter-wave RF signals; and a plurality of RF sub-modules for performing at least up and down conversions of intermediate frequency (IF) signals and controlling the plurality of antenna arrays, each of the plurality of RF sub-modules is connected to an antenna array of the plurality of antenna arrays, wherein the plurality of RF sub-modules are chained to each other through a first transmission line and one of the plurality of RF sub-modules is connected to a baseband module through a second transmission line, each of the first transmission line and the second transmission line transfers a multiplexed signal including an IF signal, a local oscillator (LO) signal, a control signal, and a power signal.

### CROSS REFERENCE TO RELATED APPLICATIONS

This application is a continuation-in-part of U.S. patent application Ser. No. 13/153,667 filed Jun. 6, 2011, the contents of which are hereby incorporated by reference.

### TECHNICAL FIELD

The present invention generally relates to radio frequency (RF) systems, and more particularly to partitioning of RF system modules.

### BACKGROUND OF THE INVENTION

The 60 GHz band is an unlicensed band which features a large amount of bandwidth and a large worldwide overlap. The large bandwidth means that a very high volume of information can be transmitted wirelessly. As a result, multiple applications, that require transmission of a large amount of data, can be developed to allow wireless communication around the 60 GHz band. Examples for such applications include, but are not limited to, wireless high definition TV (HDTV), wireless docking stations, wireless Gigabit Ethernet, and many others.

In order to facilitate such applications there is a need to develop integrated circuits (ICs), such as amplifiers, mixers, radio frequency (RF) analog circuits, and active antennas that operate in the 60 GHz frequency range. An RF system typically comprises active and passive modules. The active modules (e.g., a phase-array antenna) require, control and power signals for their operation, which are not required by passive modules (e.g., filters). The various modules are fabricated and packaged as RFICs that can be assembled on a printed circuit board (PCB). The size of the RFIC package may range from several to a few hundred square millimeters.

In the market of consumer electronics, the design of electronic devices, and thus RF modules integrated therein, should meet the constraints of minimum cost, size, power consumption, and weight. The design of the RF modules should also take into consideration the current assembly of electronic devices, and particularly handheld devices, such as laptop and tablet computers in order to enable efficient transmission and reception of millimeter wave signals.

A schematic diagram illustrating the assembly of a laptop computer 100 that includes an RF system 110 for transmission and reception of millimeter wave signals is shown in FIG. 1. The form factor of the RF system 110 is spread between the base 102 and lid planes 105 of the laptop computer 100.

The RF system 110 includes two parts: a baseband module 120 and RF module 130 respectively connected to the base plane 102 and lid plane 105. The RF module 130 includes active transmit (TX) and receive (RX) antennas. When transmitting signals, the baseband (BB) module 120 typically provides the RF module 130 with control, local oscillator (LO), intermediate frequency (IF), and power (DC) signals. The control signal is utilized for functions, such as gain control, RX/TX switching, power level control, sensors, and detectors readouts. Specifically, beam-forming based RF systems require high frequency beam steering operations which are performed under the control of the baseband module 120. The control typically originates at the baseband 120 of the system, and transfers between the baseband module 120 and RF module 130.

The RF module 130 typically performs up-conversion, using a mixer (not shown) on IF signals to RF signals and then transmits the RF signals through the TX antenna according to the control of the control signal. The power signals are DC voltage signals that power the various components of the RF module 130.

In the receive direction, the RF module 130 receives RF signals at the frequency band of 60 GHz, through the active RX antenna and performs down-conversion, using a mixer, to IF signals using the LO signals, and sends the IF signals to the baseband module 120. The operation of the RF module 130 is controlled by the control signal, but certain control information (e.g., feedback signal) is sent back to the baseband module 120.

To improve the radio coverage, the RF system 110 should include multiple antenna arrays. That is, the RF system 110 often utilizes an antenna diversity to improve the quality and reliability of the wireless link. The antenna arrays may include, for each direction, multiple active antenna arrays, e.g., a phased array, in which each element can be controlled individually to enable the usage of beam-forming techniques.

However, such an implementation limits the performance of the RF system. Specifically, there are a number of constraints that should be met when designing the RF module 130. Such constraints necessitate that the physical dimensions, the power consumption, heat transfer, and cost should be as minimal possible. In addition, the routing of signals between the antenna arrays to the RF circuitry should be as short as possible to reduce energy losses of RF signals.

Furthermore, a complete new design of an RF module is needed for different antenna diversity requirements. That is, an RF module design that supports a single antenna array cannot be reused for an RF module that supports two antenna arrays. In addition, when the higher antenna diversity is required, the complexity of a design of a RF module is significantly increased as the above-mentioned design constraints must be met.

It would be therefore advantageous to provide an RF module, and a solution for a simple design of such a module, in an electronic device for use in at least the 60 GHz frequency band, that would efficiently support antenna diversity requirements.

### SUMMARY OF THE INVENTION

Certain embodiments disclosed herein include a modular millimeter-wave radio frequency (RF) system. The system comprises a plurality of active antenna arrays for receiving and transmitting millimeter-wave RF signals; and a plurality of RF sub-modules for performing at least up and down conversions of intermediate frequency (IF) signals and controlling the plurality of antenna arrays, each of the plurality of RF sub-modules is connected to an antenna array of the plurality of antenna arrays, wherein the plurality of RF sub-modules are chained to each other through a first transmission line and one of the plurality of RF sub-modules is connected to a baseband module through a second transmission line, each of the first transmission line and the second transmission line transfers a multiplexed signal including an IF signal, a local oscillator (LO) signal, a control signal, and a power signal.

Certain embodiments disclosed herein also include a radio frequency (RF) sub-module integrated in a millimeter-wave RF system to support antenna diversity. The RF sub-module comprises a chip-to-line interface coupled to a first transmission line and designed for transferring a multiplexed signal to an adjacent RF sub-module, wherein the multiplexed signal includes an intermediate frequency (IF) signal, a local oscillator (LO) signal, a control signal, and a power signal; a RF circuitry coupled to an active antenna array and designed for performing at least up and down conversions of IF signals and controlling the active antenna array; and a line-to-chip interface unit coupled to the RF circuitry and a second transmission line and designed for receiving the multiplexed signal and providing the IF signal, the LO signal, the control signal, and the power signal to the RF circuitry.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a diagram illustrating the assembly of a laptop computer having radio transmission capabilities in the 60 GHz band.

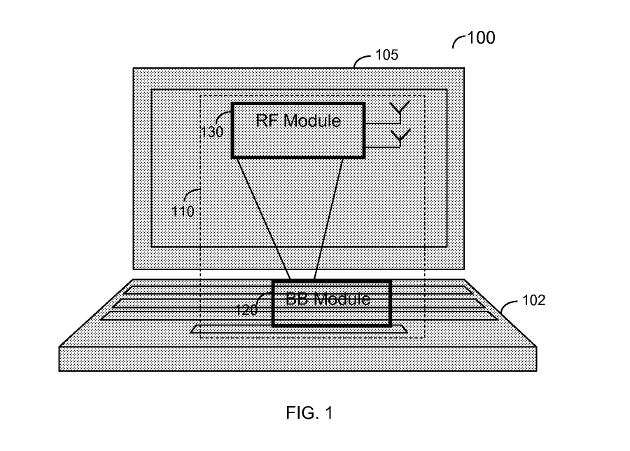

FIG. 2 is a diagram of a RF system utilized to describe various embodiments of the invention.

FIG. 3 is a diagram of showing an arrangement of RF sub-modules in the modular RF module according to one embodiment of the invention.

FIG. 4 is a block diagram of a RF sub-module designed according to one embodiment.

### DETAILED DESCRIPTION OF THE INVENTION

The embodiments disclosed by the invention are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

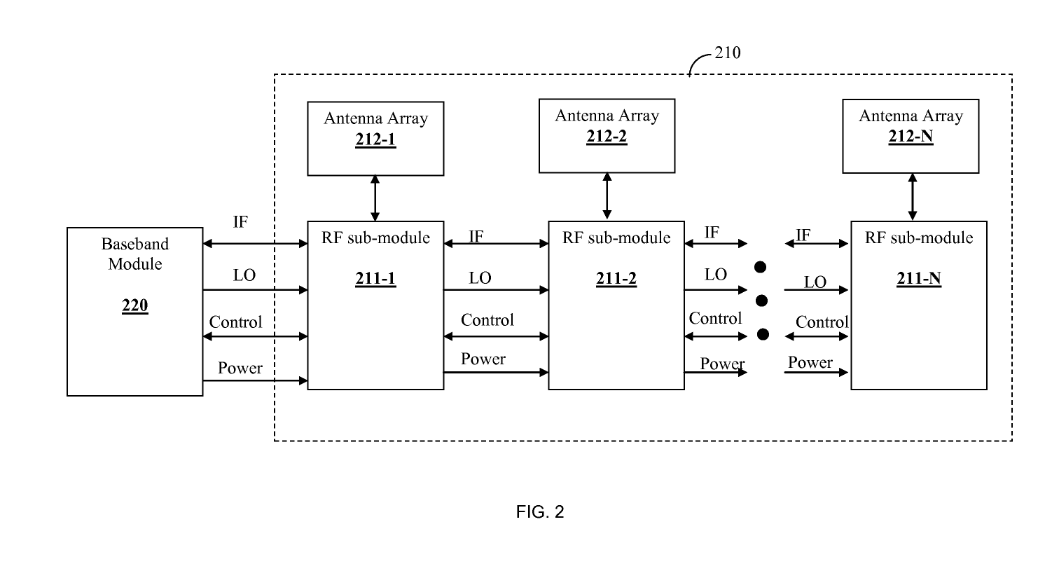

A schematic diagram of an RF system 200 utilized to describe various embodiments of the invention is illustrated in FIG. 2. The RF system 200 includes a modular RF module 210 and a baseband module 220 and enables the efficient transmission and reception of radio signals in at least the 60 GHz band. The modular RF module 210 is designed as a modular module that includes a plurality of RF sub-modules 211-1 through 211-N. Each of the RF sub-modules 211-1 through 211-N is connected to its respective antenna array 212-1 through 212-N. In one embodiment, each of the arrays 212-1, 212-N is a phased array antenna to receive and/or transmit radio signals at least at the 60 GHz frequency band. As demonstrated below, the solution of a modular RF module allows a simple design of a RF module that supports high antenna diversity while meeting the design constraints of RFICs.

One of the sub RF modules, e.g., a sub-module 211-1, is connected to a baseband module 220. The RF and baseband modules 210 and 220 are apart from each other and are connected using a single transmission line for transferring at least the power, control, IF, and LO signals. In another implementation, these signals can be transferred over three separate transmission lines, where the power signal is multiplexed with one of the IF, control and LO signal. Alternatively, these signals can be transferred over two separate transmission lines, where the LO and IF signals are multiplexed on one line, and the control is on the other transmission line. Alternatively, the IF and control signals are multiplexed on one line, while the LO signal is transferred on the other transmission line. The power signal is multiplexed on one of the two separate transmission lines. In certain embodiments, the power signal can be provided to the sub-modules from a power source directly connected to the RF module.

The baseband and RF modules 220 and 210 are respectively located at the base and lid planes of a laptop computer. Placing the baseband module 220 and RF module 210 apart from each other is required to locate the active antennas at such a location where optional reception/transmission of signals may be achieved. Such a location is typically not in proximity to the baseband module 220 which is usually placed by the device's fan/ventilation. As another example, in a tablet computer, the baseband and RF modules 220 and 210 are located at opposite ends of the tablet.

Each of the plurality of RF sub-modules 211-1 through 211-N can perform the tasks including, in part, performing up and down conversions of radio signals received/transmitted through the antenna arrays 212-1 through 212-N and controlling the antenna arrays 212-1 through 212-N. All the RF sub-modules 211-1 through 211-N have the same structure, and hence the same design.

One of the plurality of RF sub-modules, e.g., sub-module 211-1 is configured as a master while the other are slaves. The last RF sub-module in the arrangement, e.g., sub-module 211-N, is configured as an end sub-module. All the slave RF sub-modules, e.g., sub-modules 211-2 are intermediate sub-modules. As will be described in detail below, intermediate sub-modules transfer the IF, LO, power, and control signals to their adjacent module, while the end sub-module only receives the signals and terminates them at its output. The RF sub-modules are hard-coded to function as a master, an intermediate salve, or an end sub-module. The hard coding may be achieved by setting one of the RFIC's external pins to HIGH or LOW logic level. In addition, the commands, encapsulated in the control signal, are sent from the baseband module 220 and are received by all the sub-modules 211-1 to 211-N. Each command consists of a sub-module ID, thus only if the sub-module ID matches, the respective RF sub-module executes the command. For example, requesting temperature data from the RF sub-module 211-2, all the sub-modules 211-1 to 211-N listen to the command, but only sub-module 211-2 responds.

The RF sub-modules 211-1 through 211-N can operate in different modes of operation, including a standalone mode, wherein only one module is included, an expansion mode, and a diversity mode. An exemplary Table 1 shows the mode of operation of two RF sub-modules 211-1 and 211-2.

TABLE 1

| | | Sub-Module | | Sub-Module | |
|---|---|---|---|---|---|
| operation | Antenna Array | 211-1 | | 211-2 | |
| Mode | Type | Active | Type | Active | Type |
| Expansion | 2X | Yes | Master | Yes | Slave |
| Diversity | 1X (Master or | Yes | Master | Yes | Slave |
| | Slave) | | | | |
| | 1X | Yes | Master | No | Pending |
| | 1X | No | Pending | Yes | Slave |
| | 2X | | | | |

In the expansion mode of operation, the plurality of antenna arrays 212-1 through 212-N act as a single antenna array through a single control. In the example provided in Table 1, both the RF sub-modules 211-1 and 211-2 are active, while the RF sub-module 211-1 is the master and the sub-module 211-2 is the slave.

In the diversity mode, two or more RF sub-modules are activated depending on the current reception/transmission requirements. That is, the antenna arrays 212-1, 212-N do not act as a single array, but rather each antenna array is independently controlled. For example, as described in Table 2, at any given time, any combination of the RF sub-modules 211-1 and 211-2 and their respective arrays 212-1 and 212-2 can be active. The baseband module 220 sets the mode of operation and controls the operation of the RF sub-modules and antenna arrays in both modes of operation.

In one embodiment, the modular RF module 210 and baseband module 220 are fabricated on different substrates and connected using a transmission line (e.g., a cable). According to another embodiment, the RF and baseband modules are fabricated on the same substrate and are connected using a coaxial cable.

As schematically illustrated in FIG. 2, at least four different signals are simultaneously transferred between the baseband module 220 and the master RF sub-module 211-1. In addition, these signals are routed to the slave RF sub-modules 211-2 through 211-N. These signals include, but are not limited to, power, control, IF, and LO. The IF and control signals are transferred in both directions between connected modules, while the power and LO signals are sent in the direction from the baseband module 220 to the RF sub-modules 211-1 through 211-N. The control signal controls, at least, the switching of the TX and RX active antennas, the direction of the antenna (beam forming), and gain control. The LO signals are required for synchronization and performing of up and down conversions of high frequency signals. The IF signals are down converted signals of RF signals that are received or should be transmitted.

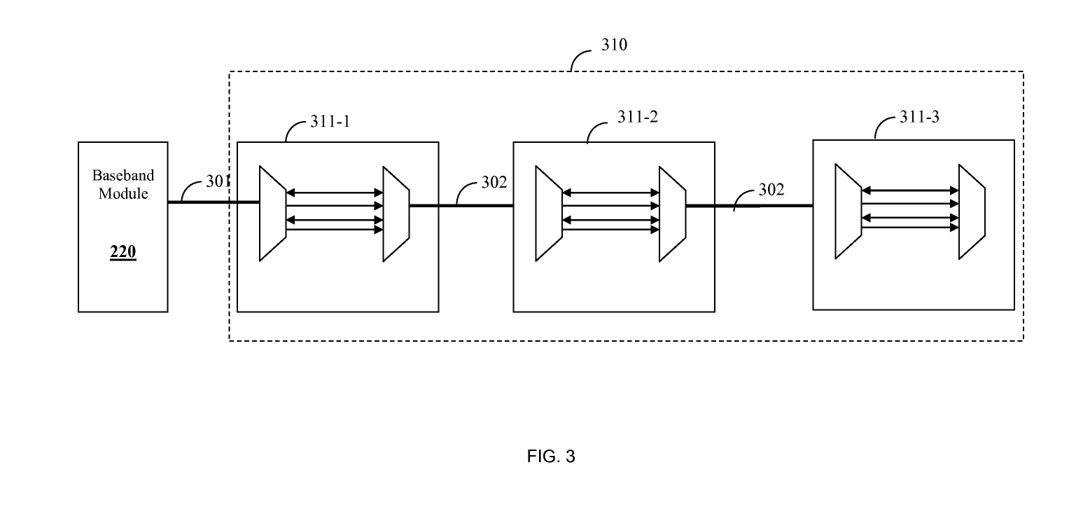

In one embodiment, the LO, IF, control and power signals are transported over a single transmission line. As illustrated in FIG. 3, a transmission line 301 connects the baseband module 220 and the master RF sub-module 311-1. In additional, a transmission line 302 is chained between RF sub-modules 311-1, 311-2, and 311-3 of a modular RF module 310. In the arrangement shown in FIG. 3, the RF sub-modules 311-2 and 311-3 are respectively intermediate slave sub-modules and end slave sub-modules.

In accordance with this embodiment, each of the transmission lines 301 and 302 is a standard micro coaxial cable. A connection between a PCB and the micro coaxial cable is made using a micro connector. According to another embodiment, each of the transmission lines 301 and 302 can be formed by fabricating a metal line on a multilayer substructure.

Each signal transferred over the transmission lines 301 and 302 has a different frequency band. With this aim, one of a set of predefined frequency plans is utilized to enable the efficient transfer of the LO, IF, power, and control signals over a transmission line. For example, according to one plan, the frequencies of f_{IF}, f_{LO}, and f_{CTRL} are set to 13-17.4 GHz, 7-8.2 GHz, 200 Mhz-1.5 GHz respectively. The frequencies f_{IF}, f_{LO}, and f_{CTRL} respectively represent the frequencies of the IF, LO and control signals. As another example, the frequency plan may be set as follows: the f_{IF} is 13 GHz to 17.4 GHz; the f_{LO} is below 1 GHz, and the f_{CTRL} is 200 MHz to 1.5 GHz. In yet another example, the f_{IF} is 5 GHz to 10 GHz, the f_{LO} band is below 100 MHz, and the f_{CTRL} is above 10 GHz. Another frequency plan that can be utilized to transfer the signals is: f_{IF} is 5 GHz to 10 GHz, the f_{LO} is above 15 GHz, and the f_{CTRL} of the control signal is 200 MHz to 1.5 GHz. A detailed discussion of the various techniques for defining the above-listed frequency plans and can be found in a co-pending U.S. patent application Ser. No. 13/153,667 (hereinafter the '667 application), assigned to the common assignee and incorporated herein by reference in its entirety.

To allow the chaining of the transmission line 302 through the plurality of RF sub-modules 311-1, 311-2, and 311-3, each RF sub-module includes a multiplexer and a de-multiplexer for interleaving the signals according to a frequency plan. It should be noted that the modular RF module 310 includes only three RF sub-modules for the mere purpose of an example used for ease of understanding of the various embodiments disclosed herein.

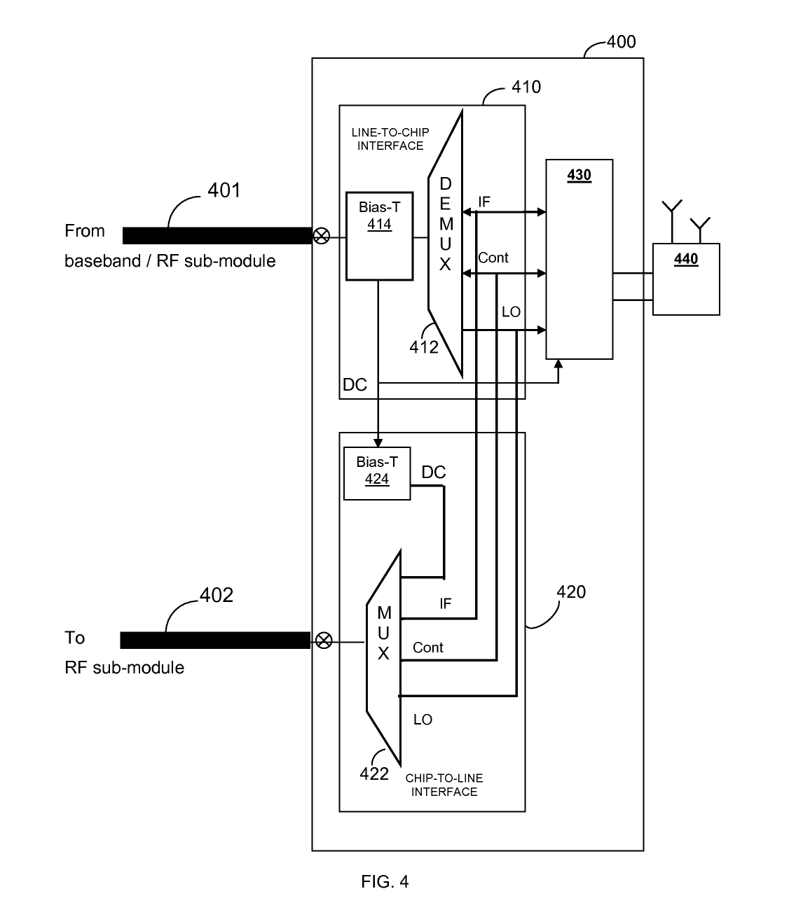

FIG. 4 shows an exemplary and non-limiting block diagram of a RF sub-module 400 designed according to one embodiment. As mentioned above, all the RF sub-modules that are part of the RF module have the same structure and design and can be configured to perform same or similar functionality. Thus, RF sub-modules can be added to the design of the modular RF module, ad-hoc, based on the specification requirements of a vendor of the handle device. Therefore, it should be appreciated that the design of the modular RF module can be easily adapted to support at least the diversity requirements. For example, if a vendor A requires an RF module with a diversity of four antenna arrays, then four RF sub-modules are included in the RF module design. If a vendor B requires a RF module with a diversity of two antenna arrays, then two RF sub-modules are included in the RF module design. The basic RF sub-module is always the same, regardless of the diversity requirements. Thus, in contrast to conventional design approaches, the modular RF module and sub-modules, disclosed herein, eliminate the need for a new scratch design of a RF module when at least the diversity requirements are different.

The RF sub-module 400 includes a line-to-chip interface unit 410, and a chip-to-line interface 420 respectively connected to a transmission line 401 and 402. The transmission line 401 may be input from the baseband module 220, when the module 400 is a master, or from another RF sub-module. The transmission line 402 is connected to another RF sub-module. The RF sub-module 400 also includes a RF circuitry 430 connected to an antenna array 440. The RF circuitry 430 performs up and down conversions of radio signals and controls the antenna array 440. As mentioned above, the antenna array may be an active phased array antenna, thus the control includes steering the beam of the antenna and/or switching the antenna between active and pending states depending on the mode of operation.

During the simultaneous transfer of the LO, IF, control and power signals over each of the transmission lines 401 and 402, the interface units 410 and 420 are utilized. Specifically, the interface units 410 and 420 multiplex the various signals and impedance matches between the transmission lines 401 and 402 and a PCB to which other RF sub-modules 400 are connected.

The line-to-chip interface unit 410 includes a demultiplexer (DEMUX) 412 and a Bias-T unit 414. The demultiplexer 412 de-multiplexes the input signals received on the transmission line 401 (either from the baseband module or another master module 402), to generate the control signal, IF signal, and LO signal. The Bias-T unit 414 extracts the DC voltage signal to power the RF circuitry 430 and antenna array 440. It should be noted that the DC voltage signal is always provided to the modules 430 and antenna array 440 to enable proper operation. The de-multiplexer 412 also performs a multiplexing operation on the IF signal (results of a down conversion of the received RF signals) and control signal to be transferred over the line 401 back to the baseband module, either directly or through another RF sub-system.

The chip-to-line interface unit 420 includes a multiplexer 422 and a Bias-T unit 424. The multiplexer 422 multiplexes the IF signal, LO signal, and control signal, as produced by the de-multiplexer 412, to be output on a single output provided to the input of the Bias-T unit 424. The Bias-T unit 424 adds a DC voltage signal extracted by the Bias-T unit 414 and outputs the signal to the transmission line 402. The multiplexer 422 also performs a de-multiplexing operation to produce the IF signals and control signal transferred from a different RF sub-module chained to the module 400 through the transmission line 402. In certain embodiments, the Bias-T units 414 and 424 are implemented as a single unit that can extract and add the DC signal to the AC signal. A detailed description of a Bias-T unit that can perform the functions of the Bias-T units 414 and 424 can be find in the '667 application.

In one embodiment, the line-to-chip interface unit 410, chip-to-line interface unit 420, RF circuitry 430, and Bias-T units 414 and 424 are fabricated in a RFIC. In another embodiment, the line-to-chip interface unit 410, chip-to-line interface unit 420, RF circuitry 430 are fabricated in a RFIC. The Bias-T units 414 and 424, on the other hand, are part of a PCB, thus the DC signal multiplexing/demultiplexing is performed over the PCB. The antenna arrays 440 are printed on the PCB. It should be noted that if the modular RF module includes multiple RF sub-modules 400, then the RF module in its entirety is fabricated in a single RFIC.

In one embodiment, the source of the LO signal is at one of the sub-modules, e.g., the master RF sub-module. Accordingly, the LO signal is multiplexed with the received IF signal (after down conversion) and transferred to the baseband module over the transmission line 401 and to the other sub-modules over the line 402.

According to certain embodiments, the multiplexer 422 separates the frequency spectrum to three different frequency bands: f_{IF}, f_{LO}, and f_{CTRL} to multiplex the LO signal, IF signal, and control signal in these bands respectively. To this aim, the multiplexer 422 includes a high-pass filter, a band-pass filter, and a low-pass filter, each passes signals in the f_{IF}, f_{LO}, and f_{CTRL} respectively. The frequency bands of the filters are set according to f_{IF}, f_{LO}, and f_{CTRL} as defined by the frequency plan.

The de-multiplexer 412 also includes a high-pass filter, a band-pass filter, and a low-pass filter that filter the multiplexed signal received on the transition line to the IF signal, LO signal, and control signal respectively. The filtering is performed based on the frequency bands of f_{IF}, f_{LO}, and f_{CTRL} as defined by the frequency plan. A detailed description of a multiplexer and de-multiplexer that can perform the functions of the multiplexer 422 and de-multiplexer 412 can be find in the '667 application.

In accordance with certain embodiments, an RF sub-module disclosed herein can be modeled as a library of cells and characterized by design parameters, such as size, power consumption, heat transfer, functions, and so on. The library can be loaded to a database of a computer aided design (CAD) tool, an electronic design automation (EDA) system, and the like. Thus, an IC designer, when designing a RF module, can select the library of the RF sub-module from the database to create a physical IC design layout. To the layout, as many as necessary RF sub-modules, can be added to support the antenna diversity. Typically, a cell includes patterns in a multiple of layers of the substrate arranged within a cell frame, for forming a semiconductor integrated circuit.

It is important to note that these embodiments are only examples of the many advantageous uses of the innovative teachings herein. Specifically, the innovative teachings disclosed herein can be adapted in any type of consumer electronic devices where reception and transmission of millimeter wave signals is needed. Moreover, some statements may apply to some inventive features but not to others. In general, unless otherwise indicated, it is to be understood that singular elements may be in plural and vice versa with no loss of generality.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A modular millimeter-wave radio frequency (RF) system, comprising:
a plurality of active antenna arrays for receiving and transmitting millimeter-wave RF signals; and
a plurality of RF sub-modules for performing at least up and down conversions of intermediate frequency (IF) signals and controlling the plurality of antenna arrays, each of the plurality of RF sub-modules is connected to an antenna array of the plurality of antenna arrays, wherein the plurality of RF sub-modules are chained to each other through a first transmission line and one of the plurality of RF sub-modules is connected to a baseband module through a second transmission line, each of the first transmission line and the second transmission line transfers a multiplexed signal including an IF signal, a local oscillator (LO) signal, a control signal, and a power signal.

2. The modular millimeter-wave RF system of claim 1, wherein the modular millimeter-wave RF circuit is located away from the baseband module.

3. The modular millimeter-wave RF system of claim 1, operates at least at a 60 GHz frequency band.

4. The modular millimeter-wave RF system claim of 1, wherein each of the first transmission line and the second transmission line is any one of: a micro coaxial cable and a metal line fabricated on a multilayer substrate.

5. The modular millimeter-wave RF system of claim 1, wherein each of the plurality of RF sub-modules is integrated in a single RF integrated circuit (RFIC) and the plurality of antenna arrays are printed on a printed circuit board (PCB), wherein the RFIC is mounted on the PCB and electrical connections connect the plurality of antenna arrays to their respective RF sub-modules.

6. The modular millimeter-wave RF system of claim 1, wherein each of the plurality of RF sub-modules includes:
a chip-to-line interface coupled to the first transmission line for transferring the multiplexed signal to an adjacent RF sub-module;
a RF circuitry; and
a line-to-chip interface unit coupled to the RF circuitry and any one of the first transmission line and the second transmission line for receiving the multiplexed signal and providing the IF signal, LO signal, the control signal, and the power signal to the RF circuitry, wherein the line-to-chip interface unit is coupled to the second transmission line when the RF sub-module is connected to the baseband module, and the line-to-chip interface unit is coupled to the first transmission line, otherwise.

7. The modular millimeter-wave RF system of claim 6, wherein the chip-to-line interface unit comprises:
a multiplexer for multiplexing the IF signal, the LO signal, and the control signal and producing a first multiplexed signal; and
a bias-T coupled to the multiplexer for inserting the power signal to the first multiplexed signal to produce the multiplexed signal to be transferred over the single transmission line, wherein the bias-T is connected to the first transmission line.

8. The modular millimeter-wave RF system of claim 7, wherein the multiplexer signal includes:
a high-pass filter for passing signals at an IF frequency band of the IF signal;
a band-pass filter for passing signals at a LO frequency band of the LO signal; and
a low-pass filter for passing a signal at a control frequency band of the control signal, wherein the IF frequency band, the LO frequency band, and the control frequency band are set according to a frequency plan, wherein the frequency plan defines separation of a frequency spectrum to the IF frequency band, the LO frequency band, and the control frequency band.

9. The modular millimeter-wave RF system of claim 6, wherein the line-to-chip interface unit comprises:
a bias-T for extracting the power signal from the multiplexed signal to produce a second multiplexed signal, wherein the bias-T is connected to the second transmission line when the RF sub-module is connected to the baseband module, and the bias-T is connected to the first transmission line, otherwise;
a de-multiplexer coupled to an output of the bias-T for de-multiplexing the IF signal, the LO signal, and the control signal from the second multiplexed signal.

10. The modular millimeter-wave RF system of claim 9, wherein the de-multiplexer includes:
a high-pass filter for passing signals at a IF frequency band of the IF signal;
a band-pass filter for passing signals at a LO frequency band of the LO signal; and
a low-pass filter for passing a signal at a control frequency band of the control signal, wherein the IF frequency band, the LO frequency band, and the control frequency band are set according to a frequency plan.

11. The modular millimeter-wave RF system of claim 5, wherein the chip-to-line interface unit matches impedance between the PCB and the first transmission line, and wherein the line-to-chip interface module matches impedance between the PCB and any one of the first transmission line and the second transmission line.

12. The modular millimeter-wave RF system of claim 1, wherein the baseband module is located at a base plane and the modular RF module part is located at a lid plane of a laptop computer.

13. The modular millimeter-wave RF system of claim 1, wherein the plurality of RF sub-modules operates in an operation mode including at least an expansion mode and a diversity mode, wherein in the diversity mode of each RF sub-module independently controls its respective antenna array, and in the expansion mode all of the plurality of RF sub-modules control the plurality of antenna arrays to act as a single antenna array.

14. The modular millimeter-wave RF system of claim 1, wherein a RF sub-module of the plurality of RF sub-modules is modeled as a library of cells to be used by an RFIC design tool.

15. The modular millimeter-wave RF system of claim 14, wherein the number of RF sub-modules included in the modular millimeter-wave RF system is determined based in part on antenna diversity requirements.

16. The modular millimeter-wave RF system of claim 15, wherein the modular millimeter-wave RF system is designed by selecting the number of RF sub-modules from the library of cells.

17. A radio frequency (RF) sub-module integrated in a millimeter-wave RF system to support antenna diversity, comprises:
a chip-to-line interface coupled to a first transmission line and designed for transferring a multiplexed signal to an adjacent RF sub-module, wherein the multiplexed signal includes an intermediate frequency (IF) signal, a local oscillator (LO) signal, a control signal, and a power signal;
a RF circuitry coupled to an active antenna array and designed for performing at least up and down conversions of IF signals and controlling the active antenna array; and
a line-to-chip interface unit coupled to the RF circuitry and a second transmission line and designed for receiving the multiplexed signal and providing the IF signal, the LO signal, the control signal, and the power signal to the RF circuitry.

18. The RF sub-module of claim 1, wherein the RF sub-module is any one of: a master RF sub-module, an intermediate slave RF sub-module, and an end slave RF sub-module.

19. The RF sub-module of claim 18, wherein the master RF sub-module is connected to a baseband module through the second transmission line and to an adjacent RF sub-module through the first transmission line, wherein the adjacent RF sub-module is any one of an intermediate slave RF sub-module and an end slave RF sub-module.

20. The RF sub-module of claim 18, wherein the intermediate slave RF sub-module is connected to two adjacent RF sub-modules through the first transmission line, wherein each of the two adjacent RF sub-modules is any one of: a master RF sub-module, an intermediate slave RF sub-module, and an end slave RF sub-module.

21. The RF sub-module of claim 18, wherein the end slave RF sub-module is connected to an adjacent RF sub-module through the second transmission line, wherein the end slave RF sub-module terminates the multiplexed signal to be transferred over the first transmission line.
